(19) United States
(12) Patent Application Publication
(10) Pub. No.: US 2016/0267446 A1
(43) Pub. Date: Sep. 15, 2016

(54) Method for achieving optimum quantity of money supply and increased velocity of money in a web environment based on real-time CPI calculation

(71) Applicant: Svetoslav Lazarov Gramenov, Varna (BG)

(72) Inventor: Svetoslav Lazarov Gramenov, Varna (BG)

(21) Appl. No.: 14/656,742

(22) Filed: Mar. 13, 2015

(51) Int. Cl. G06Q 20/06; G06Q 20/10

(52) U.S. Cl. CPC G06Q 20/0652; G06Q 20/102

(57) ABSTRACT

The invention provides a method for optimum quantity of money supply in a monetary system, implemented in a web environment with a multitude of users—individuals and legal entities, transacting with each other within a centralized authority, via units of virtual currency. The method is based on the calculation of consumer price index (CPI) in the monetary system and a negative charge on each unit of the currency (demurrage). In order for the CPI to be calculated all financial transactions in the systems are calculated and metadata is extracted in real time for the average price of certain goods and services in the system for a predefined period of time. The changes on the CPI are reflected on the demurrage where signals of inflation increase the demurrage level and signals of deflation decrease it. Optimum quantity of money is achieved through balance between money supply and demurrage.

### BACKGROUND

1. Field of Invention

The current disclosure relates generally to the operation of a monetary system implemented in a web environment that uses digital or virtual units of account with values changing through time.

2. Description of the Related Art

Demurrage is a way to balance the money supply in a monetary system. It is best explained as a cost for the holder of money who doesn't spend it in the economy. In a monetary system with implemented demurrage, money loses some of its value with time if it's not spent and/or lent out.

### The Current Monetary System

The current monetary system creates the bulk of the money units via commercial bank lending against fractional reserves—the so called “bank money” or better known as “bank deposits”. On the other hand we have money issued by a Central Bank in the form of banknotes that are given legal tender status. Bank money have been shown to make up some 97 percent of all money in circulation. These are debt based money. Normally, the money supply is affected by the rate of economic growth since when the economy is vibrant, entrepreneurs are willing to invest more and borrow more. When economy slows down, however, banks are no longer willing to lend money because there is a much higher perceived risk of defaults on the loans. Thus businesses are starved of money just when they need it the most. In effect, debt-based money exacerbates cyclicality of the economy, making both the booms and the busts stronger and longer.

Another problem in the monetary system lays in the incentives it provides for hoarding money. Money grows when it's kept in the bank and not spent because of the interest rate on deposits. However when money is hoarded it no longer acts as a medium of exchange because it doesn't circulate in the economy. This money is basically out of the commercial turnover and with time attracts even more money taking it too out of the economy.

Yet another problem is the built-in growth requirement in debt-based money via the interest feature. Since money for the interest is not created in the economy, it must be extracted by a borrower from another borrower. Constant issuing of ever-larger amounts of debt is required to keep the system moving. Eventually, this requirement of the money system may reach the finite limits of the resource endowment of our planet.

Interest-bearing, debt-based money is the root cause behind the growing inequality in society. Interest assures that the rich are likelier to get richer, while the poor—to stay poor (er).

The current money system provides few efficient instruments for money supply management. Usually money supply is reigned in by central bankers by manipulation of the interest rates in the economy, but raising the interest rates kills the economy across the board, much like a medieval doctor bloodletting a patient, and lowering interest rates is no guarantee that banks will increase their lending.

### How Demurrage Increases the Velocity of Money?

Contrary to interest, demurrage provides incentive for spending rather than hoarding money. When money decreases with time the only way for its holders to not lose value is to spend it for goods and services or lend it. Money will thus circulate much faster in the economy and stimulate economic growth making it easier for entrepreneurs to benefit from their successful investments, and putting those who rely on hoarded liquid wealth—and not on productive assets—into disadvantage.

### How can Demurrage Contribute to an Optimum Money Supply?

[0009]Demurrage can serve as a counter measure to inflationary pressures in a monetary system. While the total quantity of money consistently grows due to money issuance the money supply can also be decreased through demurrage. The alteration of the demurrage rate will affect the economy in different ways. Higher demurrage may mean increased velocity of money but it is also possible for money to become scarce if it is extinguished too quickly. Lower demurrage rate however may not be enough to match the speed of money issuance thus leading to inflation. In order for demurrage to properly balance the money supply it must be fluctuating according to the supply and demand in the economy. A fixed demurrage rate does not take into account the changing economic conditions and because of that it cannot be an effective tool for achieving optimum money supply.

How can Demurrage Avoid other Weaknesses of the Current Money System?

[0010]Demurrage makes interest rate interventions unnecessary, hence market participants can enjoy a more predictable financial playing field.

[0011]Demurrage works to alleviate inequality by penalizing the most holders of large liquid balances.

### Implementation of Demurrage in Different Currencies

[0012]Demurrage has been implemented in different monetary systems over the years. It's a natural concept for many forms of commodity money in the form of securities backed up by goods that lose some of their value over time, i.e. certificates for the possession of a certain amount of grain in storage. This type of natural demurrage cannot be controlled and is only dependent on the nature of the goods.

Other form of demurrage can be observed in metal standard currencies like E-gold. Users of the E-gold monetary system trade with a virtual currency backed by gold which is kept by the administrator of the system. There is a gold storage charge of 1 percent per annum which is supposed to cover the costs for storing the gold and operating the system. The purpose of this type of demurrage is not to balance the money in circulation but to ensure the financing of the system.

A different form of demurrage has been implemented in various local currencies like the Chiemgauer in Germany or the Worgl currency in Austria. Demurrage in these systems is implemented to increase the velocity of money and has proved successful in doing so. Holders of the banknotes are required to put a special stamp that costs a small amount of money over a certain period of time in order for the banknote to serve as a medium of exchange. Banknotes with no stamp cannot be exchanged for goods and services.

Currently modern information technology offers much more convenient ways for implementation of demurrage. It can be applied automatically without the execution of additional actions by the users of a certain currency.

### Reference to Specific Documents Related to the Invention

### US PATENT DOCUMENTS

application Ser. No. 13/470684, May 14, 2012;

application Ser. No. 13/527654, Jun. 20, 2012;

### SUMMARY

This section explains how the invention overcomes the problems pointed out in the background. The method is based on the general idea of demurrage applied to currency but develops it into a process for optimum money supply in a monetary system.

The method can be applied in web based monetary system where metadata about each payment in the system is extracted and recorded. This metadata comprises information about the payer and the payee, the goods and services purchased and the price paid. In order for such information to be available for recording and processing transactions must either be performed through a server that extracts the data or the devices of the parties on the transaction must send this data to the same server.

Once the metadata is extracted it is used to calculate the Consumer Price Index (CPI) in the environment in which the monetary system is implemented. Changes in the CPI over a certain period of time mark inflationary or deflationary processes.

The alteration of the CPI is used to determine the rate of the demurrage in the system. The demurrage is always applied in the form of a negative interest rate but the rate can vary depending on the money supply. If money becomes scarce the demurrage rate should be lower and if the money has grown too much, the rate should be higher. In order for this to be achieved the demurrage must depend on the CPI. When the CPI changes indicate inflation, the demurrage rate is high unlike deflation processes where the demurrage rate is low.

### BRIEF DESCRIPTION OF DRAWINGS

FIG. 1 illustrates the general steps of the method through a flowchart.

FIG. 2 illustrates the process of currency generation.

FIG. 3 illustrates the setting of the information loop preferences which is a precondition to the actual start of the process.

FIG. 4.1 illustrates the interaction between the users of the system upon issuing an invoice.

FIG. 4.2 illustrates the execution of a transaction by the server.

FIG. 5 illustrates the recording of a transaction of goods and services which are included in the CPI basket.

FIG. 6 illustrates the process of CPI calculation.

FIG. 7.1 illustrates the process of demurrage application.

FIG. 7.2 illustrates the changes made by the server on the user accounts when applying demurrage.

FIG. 8 illustrates an exemplary invoice interface.

### DETAILED DESCRIPTION

An exemplary embodiment, as described below, may be used to provide a method for achieving optimum quantity of money supply and increased velocity of money in a web environment.

### Ordered Sequence of the Method

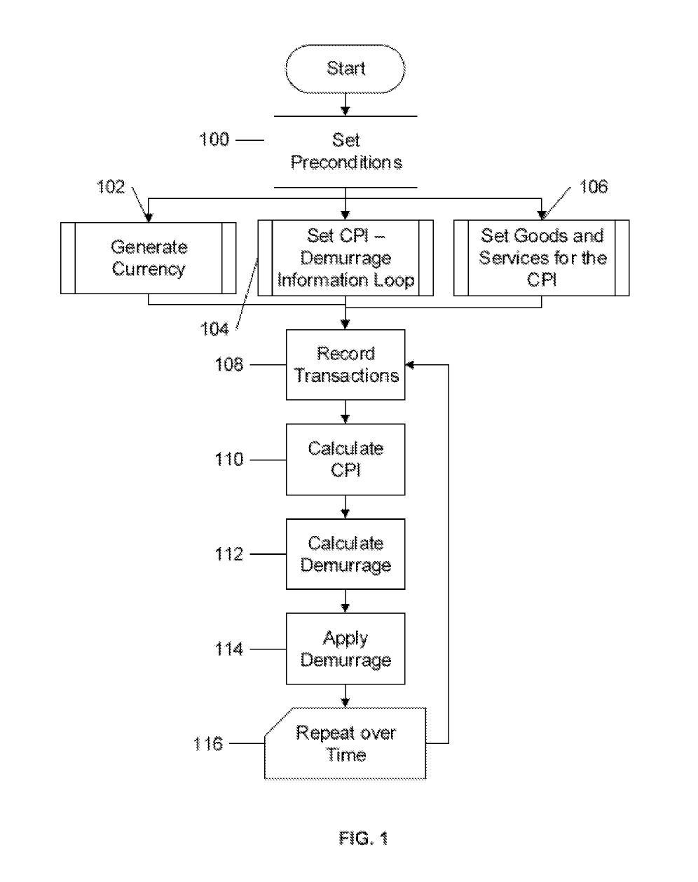

The basic fixed steps of the method will be explained with reference to FIG. 1. The process of the application of the method and its regular repetition are illustrated through a flowchart. In order for the method to be applied in a monetary system some preconditions must be set in this system (100). At first a certain form of currency must be introduced in the system (102). The current description is based on currency in the form of digital accounts of the users of the system, which accounts are recorded and managed by a central authority of the system. The method can also be applied to other types of currency units, preferably some form of digital currency which can either be devaluated remotely by a system operator or devaluate itself at a certain rate determined by the said operator of the monetary system.

This process can be described as application of a negative interest. For example if a user A has a bank account, in most cases he is entitled to receive interest which is applied by the bank simply by increasing the increasing the value in his account over certain period of time. Demurrage can be applied by the bank the same way, only this time decreasing the value in the account of the citizen.

Demurrage can only be an effective tool in achieving optimum money supply if it has a fluctuating rate according to real time economic conditions. One way to bind the demurrage with the real economy is through the Consumer Price Index (CPI) in the system. In the current description the demurrage rate is a function of the changes in the CPI. This function and the way will be referred to as CPI—Demurrage information loop (104) and will be further explained below. In order for the CPI in the system to be calculated initially and over time a consumer basket of goods and services must first be set (106). After the preconditions are set (100) the repetitive part of the method can be executed. This sub-process is repeated over a period of time, where the length of the period makes no difference. In order to make the description easy to understand we shall give an exemplary period of one month. Through this one month every transaction in the monetary system is recorded and relevant metadata is extracted (108). The metadata consists of at least what goods and services have been bought and at what price per unit. Preferably this is achieved through a digital taxonomy of goods and services and electronic invoices. All metadata from transactions that involve goods and services included in the CPI basket over the month is extracted and recorded. At the end of the month the CPI is calculated based on this data and compared to the previous month in order to measure the changes in the CPI (110). Demurrage is then also calculated (112) through the CPI—Demurrage information loop.

The final step in this repetitive sub-process is the automatic application of demurrage (114). After the demurrage rate has been calculated in the previous step, money in the system is devaluated with this rate. Let's say for example that a user has an account with 100 dollars in the system. At the end of the month demurrage rate is calculated to be 1 percent. This means that money in all accounts must be decreased by 1 percent. So the account of the user now has 99 dollars. The one dollar is not moved into another account or spent. It is extinguished and no longer exists in the monetary system. After demurrage is applied another month starts and the process is repeated (116).

### Money Creation

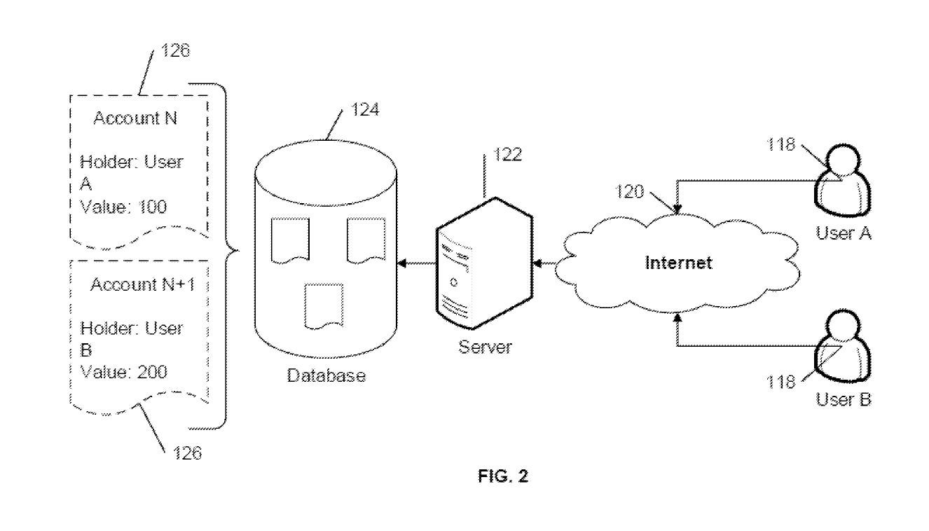

FIG. 2 illustrates an exemplary process of currency generation. The monetary system comprises users (118), a server (122) and a database (124), connected together through a network (120). Users (118) transact with each other through interaction with the server (122). Connection with the server is made through a network which can be the Internet (120) or any other type of network through which devices can send and receive data. The server function is to operate the whole monetary system. It can be managed by a managed by a centralized authority like a central bank. The server (122) extracts data from the transactions and manages the accounts of all users in a database (124). Every account (126) in the database (124) contains at least data for its owner and the amount of money in it. Changes in the accounts are made by the server either upon request of the users (when transactions are executed) or automatically (when demurrage is applied). Initially money in the system is generated through the creation of a new account or by increasing the amount of money in the account. The rate of money creation is rarely a constant so a balance in the money supply cannot be achieved with fixed demurrage rate. However how much money is created in the system is not the most important thing. What really matters in the economy is how the money created affects the ability of the members of the monetary system to buy goods and services and this is best understood when considering both the quantity of money and the changes in the Consumer Price Index.

### CPI—Demurrage

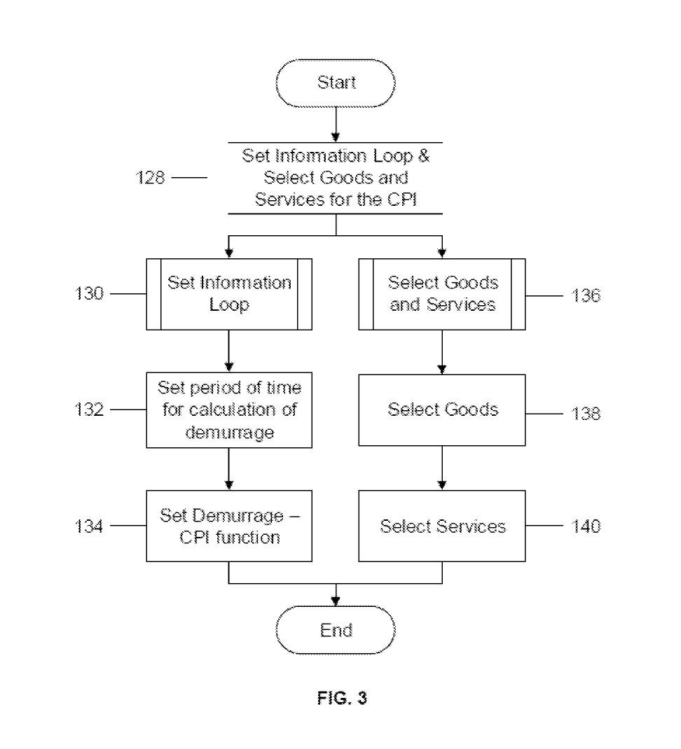

The other two preconditions are briefly described with reference to FIG. 3. It shows what basic steps must be executed in order to set the CPI—Demurrage information loop and the CPI basket (128). Two simple sub-processes are illustrated—setting the information loop (130) and choosing goods and services that are used for measurement of the CPI (136). Two aspects must be considered for the information loop. The first one is setting the length of the time period over which the CPI and demurrage are calculated (132). Since metadata is extracted from all relevant transactions the length of the system can vary and also be changed over time. If the length of the period is set to one month changes in the CPI will be measured by comparing the prices for the current month and the prices for the previous one. If the period is changed to a week for example than the prices for the current week will be compared with those of the previous week. This is possible when the metadata from the transactions comprises not only quantity of goods and services sold and price per unit but also the moment at which the transaction has been executed. The metadata is the used for calculation of the CPI and the demurrage through the Demurrage—CPI function (134). The exact function should be set by the central authority. It must be an algorithm that calculates the rate of money extinguishment depending on the changes in the CPI. Different equations can be applied to different system but the principle of the invention always remains the same. An oversimplified example is to set a demurrage rate which equals the negative change in the CPI. In this example if the CPI has changed with 1 percent, this means that prices have risen with 1 percent compared to the previous period, the demurrage will be −1 percent and money in the system will be devaluated with 1 percent.

### Transactions

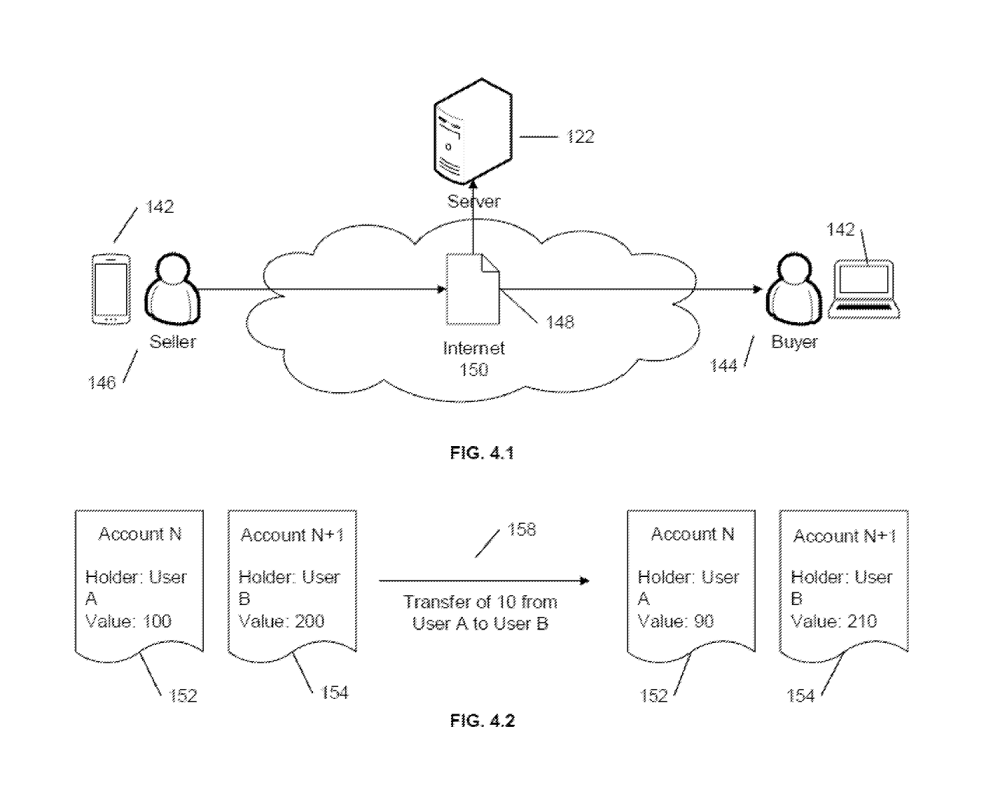

One way of executing transactions in the system will be explained with reference to FIG. 4.1 and FIG. 4.2 which show two different aspects of the transactions. FIG. 4.1 illustrates the interaction between the users and the server. A seller (146) and a buyer (144) are involved. They interact with the server through their terminal devices (142) over the network (150). The devices must be capable of sending and receiving data and visualize an interface for user interaction with the system. In order for this to be achieved simple software must be installed that enables the user to send and receive data over the network. When the parties agree to make a transaction the seller (146) sends the buyer (144) an electronic invoice (148). The electronic invoice must contain at least the moment of issuing, the goods and services sold and the price per unit. These data will be visualized on the terminal devices and will also be extracted by the server (122) and recorded in the database. Whether the buyer really pays for the goods and services in the invoice is irrelevant for the calculation of the CPI and demurrage. Information about the transaction can be sent in various ways, not just through an electronic invoice. The only important thing is that the server (122) is capable of extracting the relevant metadata. It doesn't even matter is the buyer (144) actually pays what is due.

Payments in the system are preferable also executed with the assistance of the central authority which manages the server and the database where the accounts are stored. Two accounts are depicted in FIG. 4.2. Account N (152) is the account of the payer—User A and Account N+1 (154) is the account of the payee—User B. The only other data necessary is the amount of money in each account. For the current example user A has 100 units of currency in his account and user B has 200 units of currency. When user A sends a request to the server for the transfer of 10 units of currency from his account to the account of user B (158), the only thing that the server has to do is to decrease the amount of money in the account of the payer and increase the amount of money in the account of the payee with the respective number of currency units. After the transaction is executed Account N has a value of 90 and account N+1 has a value of 210.

### Extracting Metadata

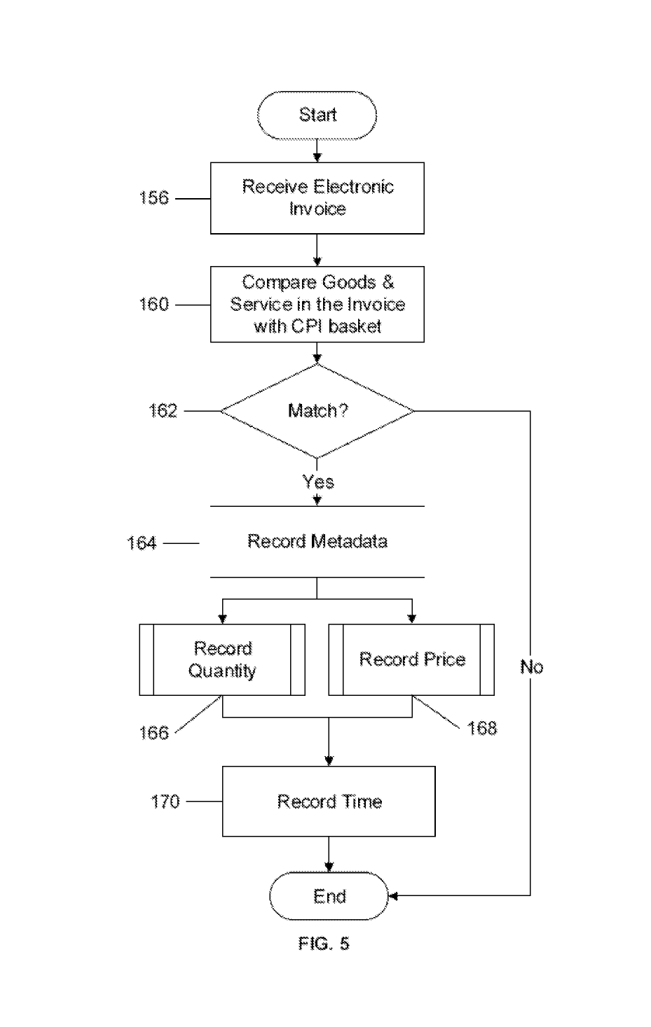

FIG. 5 illustrates a flowchart of the process of metadata extraction. The process starts when the server receives an electronic invoice (156) or other form of data for a transaction of goods and services in the system. The server than checks if any of the goods and services in the CPI basket is included in the invoice (160). For every match (162) the server records metadata (164) for quantity of the good or service (166) and the price per unit (168). In order for this to be possible taxonomy of goods and services must be developed within the network and stored in the database. Each good and service must be included in the taxonomy with its respective unit of measurement. After the data for all goods and services from the invoice that are included in the CPI basket is recorded, the server also records the time of the transaction (170).

### CPI Calculation

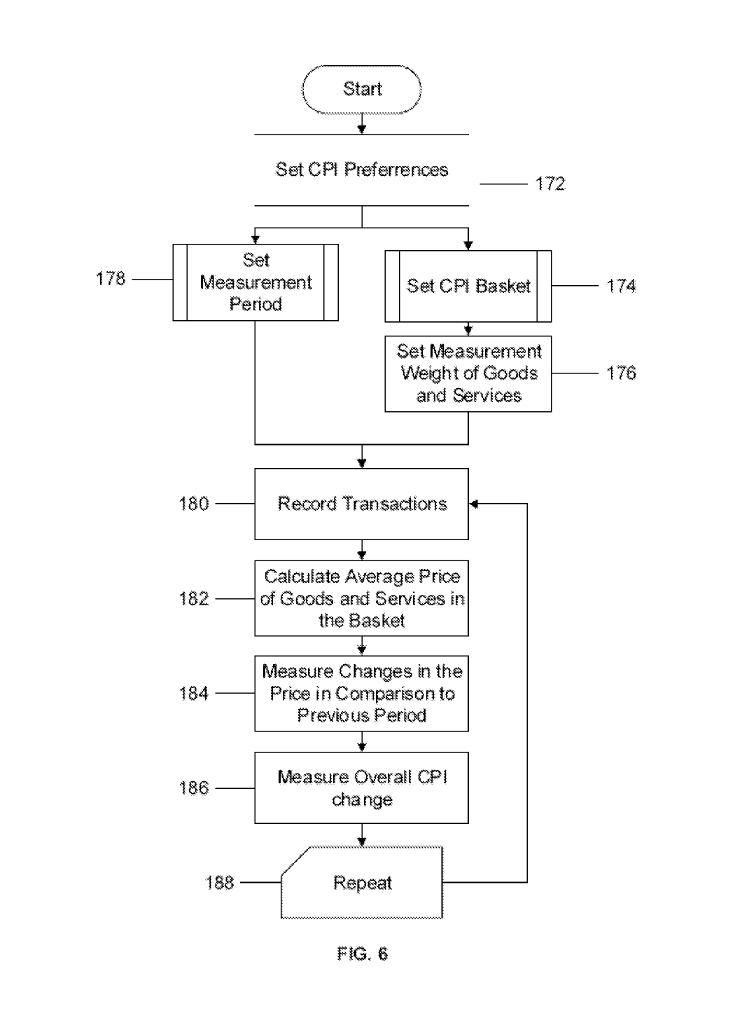

The calculation of the CPI is the next basic step in the method. It will be explained with reference to FIG. 6. Before the CPI can be calculated some preferences must be set (172). The first thing to be considered is the length if the period over which the CPI is calculated (178). The next thing is selecting goods and services for the CPI basket (174). Only the change of prices of these goods and services will be taken into account when calculating the CPI. Different goods and services may also have different measurement weight (176). After the preferences are set metadata is extracted by the server for every transaction which involves goods and services from the basket over the length of the measurement period (180). At the end of the period the server calculates the average prices of all services and goods in the basket (182) and compares them to the prices if the last period (184). Once all price changes are calculated the server measures the overall CPI change (186) and the process is repeated (188).

### Applying Demurrage

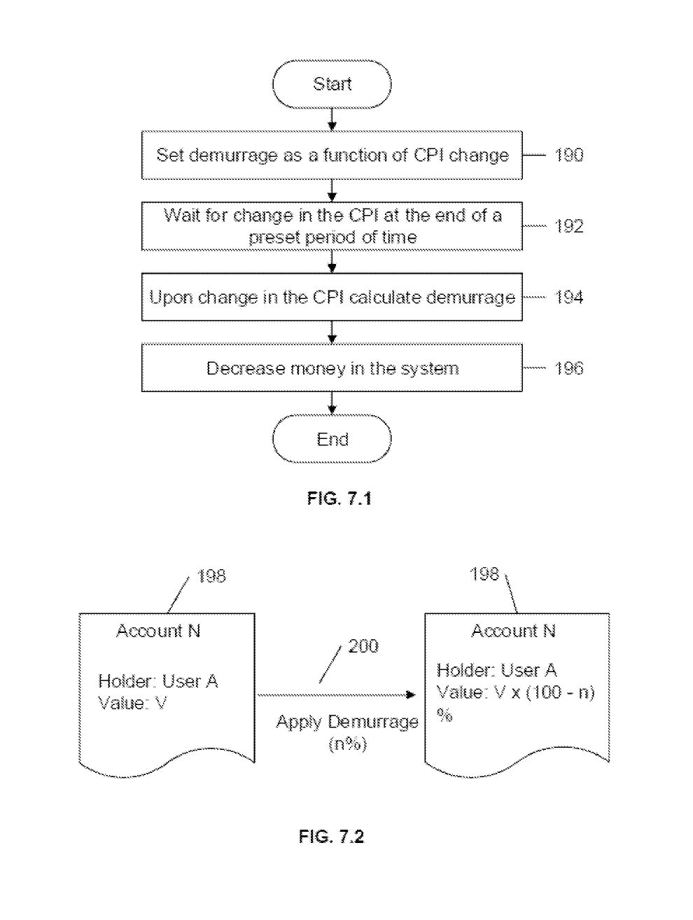

The last step in the process is the automatic application of demurrage in the system. It is illustrated in FIG. 7.1 and FIG. 7.2. In order for demurrage to be applied it must first be calculated and before a calculation is possible demurrage must be set as a function of the changes in the CPI (190). The demurrage is not changed until the CPI is measured at the end of the preset period (192). After the changes in the CPI are measured the demurrage is calculated (194) and automatically applied in the system (196) by devaluating or decreasing the money in it. As explained above this process is preferably executed by altering the data for user accounts sored in the database and managed by a central authority through the server.

FIG. 7.2 shows the alterations made by the servers on the accounts of the users upon application of demurrage. One exemplary account is involved—Account N (198), the money in which is owned by user A. The account has a value V which indicates the number of currency units in the account. When demurrage is applied (200) the value of Account N is decreased by the demurrage rate. For example if value V equals 100 and demurrage rate is 1, after the demurrage is applied the account will have a value of 100×(100−1) percent, or 99 percent of 100, namely 99. This process is executed simultaneously for all accounts in the database thus 1 percent of the money in the system is extinguished.

The purpose of demurrage is not only to balance the money supply but to also increase the velocity of money. When users are aware of the fact that their money will decrease in time they will have an incentive to spend it. However if money if demurrage is applied to all money in the system at the same time sellers of goods and services may be more willing to sell shortly after demurrage is applied in order to have more time to spend the money themselves before their value is decreased. Buyers on the other hand will try and spend their money before the application of demurrage. This may cause problems in the monetary system. In order for such problems to be evaded demurrage can only be applied to the money that is not spent for goods and services in the economy. This effect can be achieved if the server is capable of storing more complex data for the user accounts. Upon transactions when a user account is credited the server must record the amount with which the value is increased and start a separate demurrage period for this account. Let's say for example that the demurrage application period is set to 10 days and at the start of this period a user has 100 units of currency in his account. On day 5 the user receives additional 50 units of currency and his account now has a value of 150. Because these 50 units are newly transferred they should not be affected by the demurrage timer and a new period will start for them. If nothing changes in the next days, demurrage will be applied to the initial 100 units of currency on day 10 and on the other 50 units—in day 15. This means that demurrage in the system must be calculated constantly and a new measurement period will start for each unit of currency from the moment it is transferred from one account to another.

This specific aspect of the invention, described in the previous paragraph creates another problem. If one share of the money in the user account has one demurrage measurement period and the other has a different, than which share of the money will be used when the user is making a payment. One possible solution is to always decrease this money with end moment of the demurrage measurement period coming sooner. For example let's assume a user account has 100 units of currency. The demurrage measurement period for 50 of these units ends in 5 days and for the rest it ends in 10 days. When the user decides to make a transaction of 60 units of currency the server will first decrease the value of those units which demurrage measurement period ends sooner. It the current example the server will decrease the value of the 50 units that have a measurement period which ends in 5 days. Since they are not enough for the execution of the transaction the server will also decrease the rest of the account. So after the transaction the user account will have 40 units of currency with a demurrage measurement period ending in 10 days.

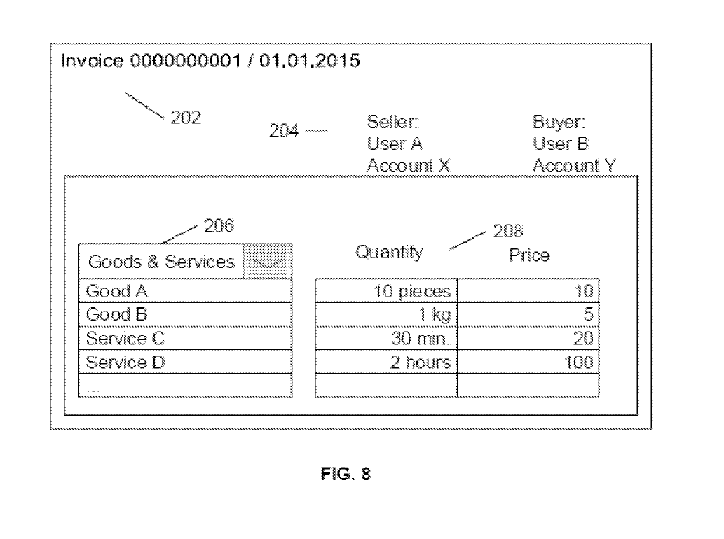

FIG. 8 illustrates an exemplary user interface for the creation of electronic invoice. The invoice must contain data for the moment of issuance (202) which can either be set by the user who issues the invoice or automatically when it is received by the server. Although not crucially important for the invention the invoice should also include data for the seller and buyer of the goods and the goods and services (204). A drop-down menu is also depicted (206). The user is given access to the whole taxonomy of goods and services in the system and can chose which to add to the invoice. After the selection of the goods and services, the user must also set the respective amount and price (208). As explained above the information for a transaction can be sent to the server in various ways and an electronic invoice is just one of the ways. FIG. 8 only shows one way of recording the information through a user interface.

Demurrage is not a new concept in economy and it has been applied in various monetary systems. The benefits of the current invention come from the possibility of CPI measurement in the monetary system and the interaction between money creation, changes in the CPI and demurrage. By design the method has many variables that can be set in one way or another in order to better suit the respective monetary system and the goals set by its operator.

What is claimed is:

1. A method comprising:
1. providing, through terminal devices, a server or a multitude of servers and a database, coupled together through a network, a monetary system, where each user has an account recorded in the database;
2. generating, through the server, a currency to be distributed among the users by altering the value of the account of each user in the database;
3. extracting metadata from transactions between the users where the metadata comprises at least moment of transaction, goods and services subject to the transaction and the currency involved;
4. wherein a taxonomy of goods and services is introduced in the system with types of goods and services and units of measurement and users are given access to the said taxonomy in order to create electronic invoices;
5. using the extracted metadata over a certain period of time to calculate consumer price index in the monetary system and changes in the index over time;
6. implementing, through the server, demurrage on the accounts of the user where the value of the accounts is decreased over periods of time at a fluctuating rate;
7. the demurrage rate being calculated as a function of the changes in the consumer price index so that an optimum money supply is achieved.

2. The method of claim 1 where currency units in the system is generated and stored in the terminal devices of the users;

3. The method of claim 1 where demurrage is not applied to currency units that have been transacted from one user to another;

4. The method of claim 1 where demurrage is calculated as function of the changes in the consumer price index and the growth of total money in circulation in the system;

5. The method of claim 1 where users create electronic invoices with data corresponding to a monetary transaction, including data for the buyer and seller, the type, quantity and price per unit for each good and service in the invoice and the moment of executing the transaction;

6. The method of claim 5 where the moment of execution of the transaction is automatically recorded by the server when an electronic invoice is received;

7. The method if claim 5 where electronic invoices are generated by the users through an interface visualized on their terminal devices;

8. The method of claim 1 where the consumer price index in the system is calculated on the basis of a consumer basket including all or part of the goods and services in the taxonomy;

9. A monetary system comprising:
1. a plurality of data processing devices, capable of sending and receiving data over a network and visualize an interface to interact with other users of the network;
2. a network, connecting all users of the monetary system; a database for recording accounts of the users of the system and metadata for transactions;
3. a server coupled through the network with the data processing devices of the users and the database, wherein the server is capable of extracting metadata from interactions between users of the monetary system, storing the metadata in the database;
4. wherein the server is capable of processing the metadata stored in the database for calculation of consumer price index in the system and demurrage, being associated with devaluation of the value of the user accounts over a preset period of time;

10. The system of claim 9 wherein taxonomy of goods and services is recorded in the database and users are given access to the taxonomy in order to create electronic invoices with their data processing devices;

11. The system of claim 9 wherein the demurrage is calculated as a function of the consumer price index by the server, the server being able to change the method of calculating the CPI and the demurrage;

12. The system of claim 9 wherein data for the user accounts is stored at the respective data processing devices of each user.
